(19) United States
(12) Patent Application Publication
(10) Pub. No.: US 2020/0201982 A1
(43) Pub. Date: Jun. 25, 2020

(54) INFORMATION PROCESSING DEVICE, TERMINAL DEVICE, INFORMATION PROCESSING SYSTEM, AND COMPUTER-READABLE MEDIUM

(71) Applicant: FUJITSU CLIENT COMPUTING LIMITED, Kanagawa (JP)

(72) Inventors: Masanori Kawahara, Kawasaki (JP); Hiroyasu Hayashida, Kawasaki (JP)

(73) Assignee: FUJITSU CLIENT COMPUTING LIMITED, Kanagawa (JP)

(21) Appl. No.: 16/690,363

(22) Filed: Nov. 21, 2019

(30) Foreign Application Priority Data
Dec. 25, 2018 (JP) 2018-241167

(51) Int. Cl. G06F 21/45; H04L 9/32; G06F 21/44; G06F 21/74

(52) U.S. Cl. CPC G06F 21/45; G06F 21/74; G06F 21/44; H04L 9/3268

(57) ABSTRACT

An information processing device includes: processing circuitry that implements a switch unit, a verification unit, and a registration unit. The switch unit switches between a registration mode in which execution of registration in management information to manage a terminal to be authenticated is enabled and a non-registration mode in which execution of the registration is disabled. The verification unit, in response to receiving a terminal registration request including terminal identification information that identifies a terminal device, certification information expressing a public key or a certificate, and an authentication code that is determined in advance from the terminal device in the registration mode, verifies the authentication code. The registration unit, in response to the authentication code being verified successfully, registers the certification information and the terminal identification information included in the terminal registration request in associate with each other in the management information.

### CROSS-REFERENCE TO RELATED APPLICATIONS

This application is based upon and claims the benefit of priority from Japanese Patent Application No. 2018-241167, filed Dec. 25, 2018, the entire contents of which are incorporated herein by reference.

### FIELD

The present disclosure relates generally to an information processing device, a terminal device, an information processing system, and a computer-readable medium.

### BACKGROUND

Techniques for authenticating devices for enhancing the security of a wireless network have been disclosed. One example of the known techniques is device authentication using a certificate or a public key.

In the conventional techniques, however, certificates or computer programs issued by an authenticating server have been distributed to users via portable media such as a USB memory, email, or the like. The user then installs the distributed computer program in his terminal device manually and later registers the terminal device in the authenticating server. Therefore, the conventional technique has had a problem in the convenience of the device authentication.

### SUMMARY

According to an aspect of the present disclosure, an information processing device includes processing circuitry configured to implement a switch unit, a verification unit, and a registration unit. The switch unit switches between a registration mode in which execution of registration in management information to manage a terminal to be authenticated is enabled and a non-registration mode in which execution of the registration is disabled. The verification unit, in response to receiving a terminal registration request including terminal identification information that identifies a terminal device, certification information expressing a public key or a certificate, and an authentication code that is determined in advance from the terminal device in the registration mode, verifies the authentication code. The registration unit, in response to the authentication code being verified successfully, registers, in the management information, the certification information and the terminal identification information included in the terminal registration request in associate with each other.

### BRIEF DESCRIPTION OF THE DRAWINGS

FIG. 1 is a schematic view illustrating an information processing system according to one embodiment;

FIG. 2 is a diagram illustrating one example of functions of an information processing system according to the embodiment;

FIG. 3A is a schematic view illustrating one example of a data structure of SSID information according to the embodiment;

FIG. 3B is a schematic view illustrating one example of a data structure of the management information according to the embodiment;

FIG. 3C is a schematic view illustrating one example of a data structure of a program information according to the embodiment;

FIG. 4 is a schematic view illustrating one example of a management screen according to the embodiment;

FIG. 5 is a schematic view illustrating another example of the management screen according to the embodiment;

FIG. 6 is a schematic view illustrating one example of an input screen according to the embodiment;

FIG. 7 is a schematic view illustrating one example of a display screen according to the embodiment;

FIG. 8A is a schematic view illustrating one example of the data structure of the SSID information according to the embodiment;

FIG. 8B is a schematic view illustrating one example of certification management information according to the embodiment;

FIG. 9 is a sequence diagram illustrating one example of the procedure of information processing to be performed by an information processing system according to the embodiment;

FIG. 10 is a flowchart illustrating one example of an interruption process to be performed by an authentication request processing unit according to the embodiment; and

FIG. 11 is a diagram illustrating one example of a hardware structure of an information processing device and a terminal device according to the embodiment.

### DETAILED DESCRIPTION

An illustrative embodiment of the present disclosure is hereinafter described. The structure of the embodiment shown below and the operation and effect obtained from the structure are just one example. In addition, the embodiment to be described below is not intended to limit the technique disclosed herein.

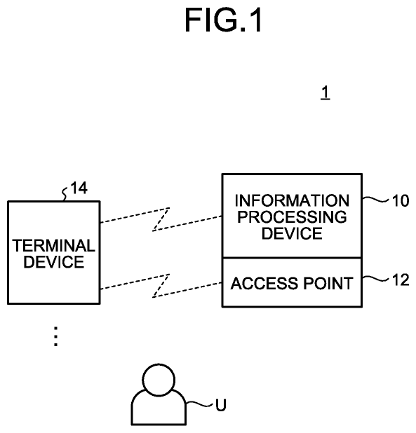

FIG. 1 is a schematic view illustrating one example of an information processing system 1 according to the present embodiment.

The information processing system 1 includes an information processing device 10, an access point 12, and a terminal device 14. The information processing device 10 and the access point 12 are connected to the terminal device 14 so that data or signals can be exchanged therebetween. In the present embodiment, the access point 12 and the terminal device 14 communicate with each other wirelessly. The information processing device 10 and the terminal device 14 communicate with each other via the access point 12. One example of the communicating method before the communication establishment is allowed is EAP (Extensible Authentication Protocol) allowing the communication with a MAC frame.

The information processing device 10 is an authenticating server for authenticating the terminal device 14. With the authentication by the information processing device 10, the terminal device 14 is connected to the network via the access point 12 of a wireless LAN (Local Area Network).

The access point 12 is a device constituting a part of the wireless LAN such as Wi-Fi (Wireless Fidelity). The access point 12 is also referred to as a wireless LAN access point, a wireless access point, or a Wi-Fi access point. In the present embodiment, the access point 12 having established the wireless connection with the terminal device 14 authenticated by the information processing device 10 connects the terminal device 14 to the network.

In the present embodiment, it is assumed that one information processing device 10 and one access point 12 are integrated. The information processing device 10 and the access point 12 are in the wired connection. Note that it is only necessary that the information processing device 10 and the access point 12 are connected so that data or signals are exchanged therebetween, and the mode is not limited to the integrated mode.

The terminal device 14 is a device to be connected to the network via the access point 12. Examples of the terminal device 14 include a personal computer (also referred to as PC below), a laptop computer, a desktop computer, and a tablet terminal.

In the present embodiment, it is assumed that one information processing device 10 and a plurality of the terminal devices 14 are connected to the network via the access point 12 of the same wireless LAN. Specifically, it is assumed that the terminal devices 14 and the access point 12 are connected wirelessly in a particular area. The particular area is, for example, a classroom or a conference room where classes or meetings are held.

In the present embodiment, it is assumed that a user U, for example an administrator, operates the information processing device 10 and the terminal devices 14 to perform the registration for authenticating the terminal devices 14. In one example, before the terminal devices 14 are used in the class, the meeting, or the like, the user U operates the information processing device 10 and the terminal devices 14 in advance. By this operation, each of the terminal devices 14 is registered in the information processing device 10. In the example described here, it is assumed that each of the terminal devices 14 and the access point 12 are made wirelessly connectable through this registration process before the usage.

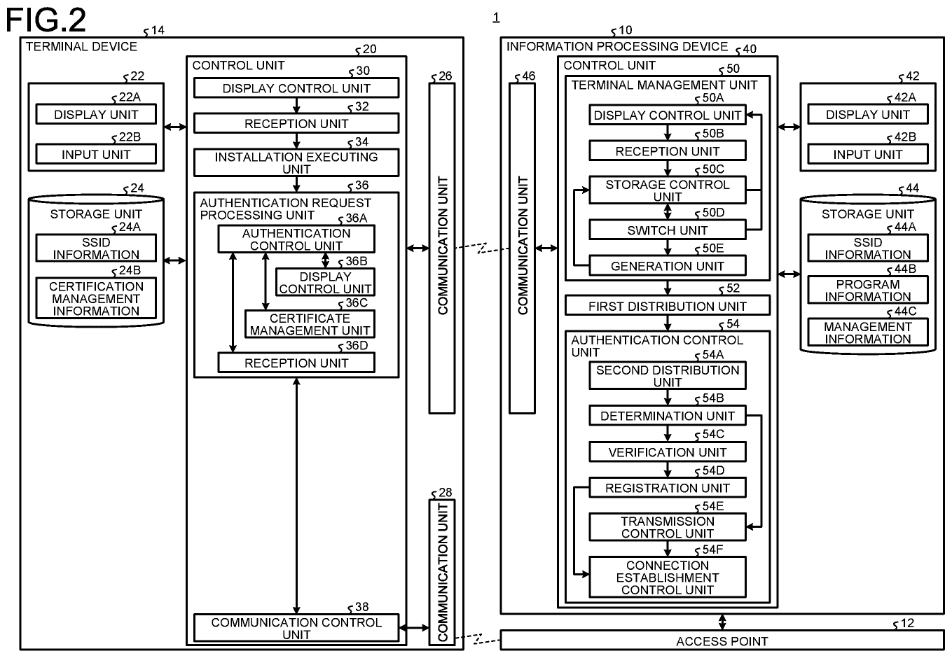

FIG. 2 illustrates one example of the functions of the information processing system 1.

First, the function of the information processing device 10 is described.

The information processing device 10 includes a control unit 40, an UI (user interface) unit 42, a storage unit 44, and a communication unit 46. The UI unit 42, the storage unit 44, and the communication unit 46 are connected to the control unit 40 so that data or signals are exchanged therebetween.

The UI unit 42 has a function of receiving the operation input from the user U and a function of displaying an image. In the present embodiment, the UI unit 42 includes a display unit 42A and an input unit 42B. The display unit 42A displays various kinds of information. Examples of the display unit 42A include known LCD (Liquid Crystal Display) and organic EL (Electro-Luminescence) display.

The input unit 42B receives various operation inputs from the user U. The input unit 42B is, for example, a position input device such as a touch pad, a key board, a pointing device, a mouse, or an input button. When the display unit 42A and the input unit 42B formed of the touch pad are formed integrally, the UI unit 42 can be used as a touch panel.

The storage unit 44 stores various kinds of information. In the present embodiment, the storage unit 44 stores SSID information 44A, program information 44B, and management information 44C therein. The storage unit 44 also stores authentication codes and scripts therein in advance. These pieces of information will be described in detail below.

The communication unit 46 is a communication interface that wirelessly communicates with the terminal device 14 via the access point 12.

The control unit 40 includes a terminal management unit 50, a first distribution unit 52, and an authentication control unit 54. The terminal management unit 50 includes a display control unit 50A, a reception unit 50B, a storage control unit 50C, a switch unit 50D, and a generation unit 50E. The authentication control unit 54 includes a second distribution unit 54A, a determination unit 54B, a verification unit 54C, a registration unit 54D, a transmission control unit 54E, and a connection establishment control unit 54F.

These units may be achieved entirely or partially in a manner that, for example, a processing device such as a CPU (central processing unit) executes a computer program, that is, using software. Alternatively, these units may be performed entirely or partially using hardware such as an IC (integrated circuit) or both software and hardware.

The terminal management unit 50 manages the terminal device 14 to be authenticated. The terminal management unit 50 includes the display control unit 50A, the reception unit 50B, the storage control unit 50C, the switch unit 50D, and the generation unit 50E.

The display control unit 50A performs control to cause the display unit 42A to display various kinds of information.

The reception unit 50B receives the input from the user U through the input unit 42B. The user U inputs by operating the input unit 42B. The reception unit 50B receives from the input unit 42B, the information or signal that is input by the operation input of the user U with the input unit 42B.

In the present embodiment, the reception unit 50B receives the input of second identification information.

The second identification information is identification information to identify the access point 12. The identification information for the access point 12 is also referred to as SSID (service set identifier).

Specifically, the second identification information is the identification information that is assigned in order to identify the access point 12 in the wireless network. In the present embodiment, the second identification information is the identification information that can uniquely identify both the access point 12 and the mode of the authentication code that is used in the device authentication.

The authentication code is a code used to authenticate the terminal device 14. The mode of the authentication code is, for example, an image or characters. That is to say, the authentication code is expressed as an image or characters. The mode of the authentication code is not limited to the image or characters.

By operating the input unit 42B, the user U inputs arbitrary identification information to identify the access point 12 connected to the information processing device 10 and the mode of the authentication code, as the second identification information. For example, the display control unit 50A causes the display unit 42A to display an input screen in order to receive the input of the second identification information. The user U, by operating the input unit 42B with reference to the input screen on the display unit 42A, inputs the second identification information in a predetermined input field. Then, the reception unit 50B receives the input of the second identification information.

Note that for the access point 12, a plurality of pieces of second identification information can be set. Therefore, the user U may input the pieces of second identification information. For example, the user U may set the second identification information for each purpose, for example, for each scene in which the terminal device 14 is used. The use of the terminal device 14 is, for example, the class or lecture but the use of the terminal device 14 is not limited thereto.

The storage control unit 50C performs control to store various kinds of information in the storage unit 44. When the reception unit 50B has received the second identification information, the storage control unit 50C registers the received second identification information in the SSID information 44A of the storage unit 44.

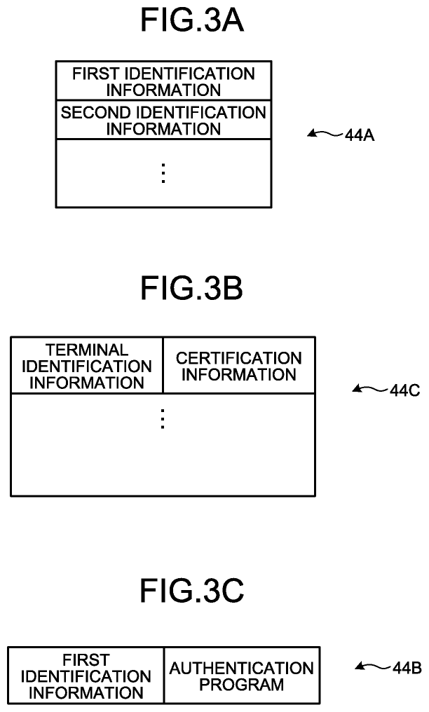

FIG. 3A is a schematic view illustrating one example of a data structure of the SSID information 44A. The SSID information 44A is a database in which the identification information (that is, SSID) set for the access point 12 is registered. Note that the data format of the SSID information 44A is not limited to the database. For example, the data format of the SSID information 44A may be a table.

In the SSID information 44A, first identification information and the second identification information are registered as the SSID set for the access point 12.

The first identification information is the identification information for an authentication program. The authentication program is a computer program for causing the terminal device 14 to perform an authentication request process for the access point 12 used in the connection to the network. The authentication request process is described in detail below. The authentication program is generated in advance for each access point 12. The authentication programs to be generated in advance for the access points 12 may be the same. The authentication program is generated in advance and registered in the program information 44B in the storage unit 44.

The first identification information is generated by the generation unit 50E to be described below, and registered in the program information 44B (details are described below).

Back to FIG. 2, the description is continued. The switch unit 50D switches the operation mode of the information processing device 10. The operation mode includes a registration mode and a non-registration mode. The switch unit 50D switches the operation mode from the registration mode to the non-registration mode or from the non-registration mode to the registration mode.

The registration mode is the operation mode in which the registration in the management information 44C can be performed. Specifically, the registration mode is the operation mode in which the registration of the terminal identification information in the management information 44C can be performed.

The non-registration mode is the operation mode in which the registration in the management information 44C cannot be performed. Specifically, the non-registration mode is the operation mode in which the registration of the terminal identification information in the management information 44C cannot be performed.

The management information 44C is the database for managing the terminal device 14 to be authenticated. The terminal device 14 to be authenticated is one example of the device authentication terminal. By the registration in the management information 44C, the terminal device 14 becomes the terminal device 14 for which the registration for the device authentication has been completed. That is to say, by the registration in the management information 44C, the terminal device 14 becomes the terminal device 14 that is allowed to connect to the network via the access point 12, that is, establish wireless connection with the access point 12 through the device authentication.

FIG. 3B is a schematic view illustrating one example of the data structure of the management information 44C. The management information 44C is a database in which terminal identification information and public keys are associated with each other. Note that the data format of the management information 44C is not limited to the database. The data format of the management information 44C may be, for example, a table.

A public key is one example of certification information. The certification information is the information used to certify that the terminal device 14 is the right terminal device 14. If the information processing system 1 performs the device authentication using a public key authentication system, the certification information is the public key. If the information processing device 10 functions as a certificate authority and the device authentication is performed using a certificate (electronic certificate) issued by the certificate authority, the certification information is the certificate.

In the example described in the present embodiment, the certification information is the public key.

Back to FIG. 2, the description is continued. The switch unit 50D switches the operation mode by receiving the input by the operation of the user U with the input unit 42B.

By operating the input unit 42B, the user U inputs the instruction of switching the operation mode from the non-registration mode to the registration mode. For example, the user U, by operating a particular display area on a management screen, inputs the instruction of switching the operation mode from the non-registration mode to the registration mode.

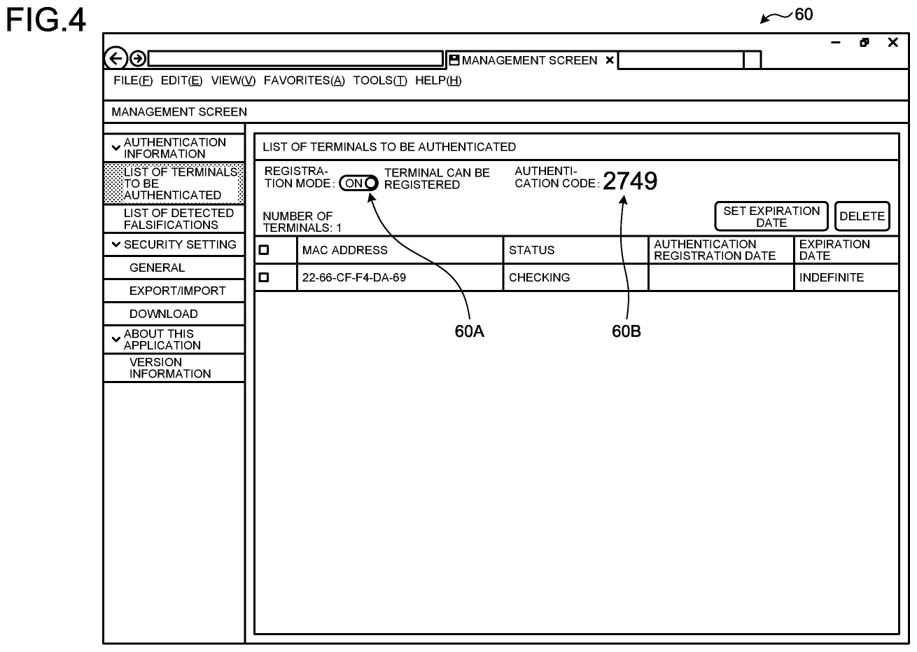

FIG. 4 is a schematic view illustrating one example of a management screen 60. The management screen 60 includes an operation mode display field 60A expressing the current operation mode. The user U inputs the instruction of switching the operation mode to the registration mode by operating the operation mode display field 60A to select “registration mode”.

Note that the management screen 60 may include a display field 60B for the authentication code. When the operation mode has been switched to the registration mode, the display control unit 50A may read the authentication code from the storage unit 44 and display the authentication code in the display field 60B of the management screen 60.

Back to FIG. 2, the description is continued. The switch unit 50D having received the instruction of switching the operation mode to the registration mode from the input unit 42B switches the operation mode from the non-registration mode to the registration mode. For example, by storing the information expressing the registration mode in the storage unit 44 as the information expressing the current operation mode, the switch unit 50D switches the operation mode to the registration mode. Note that the default operation mode is the non-registration mode.

On the other hand, by operating the input unit 42B after performing the device authentication of the terminal device 14, the user U inputs the instruction of switching the operation mode from the registration mode to the non-registration mode. For example, the user U inputs the instruction of switching the operation mode to the non-registration mode by operating an operation mode display field 60A on the management screen 60 to select “non-registration mode”.

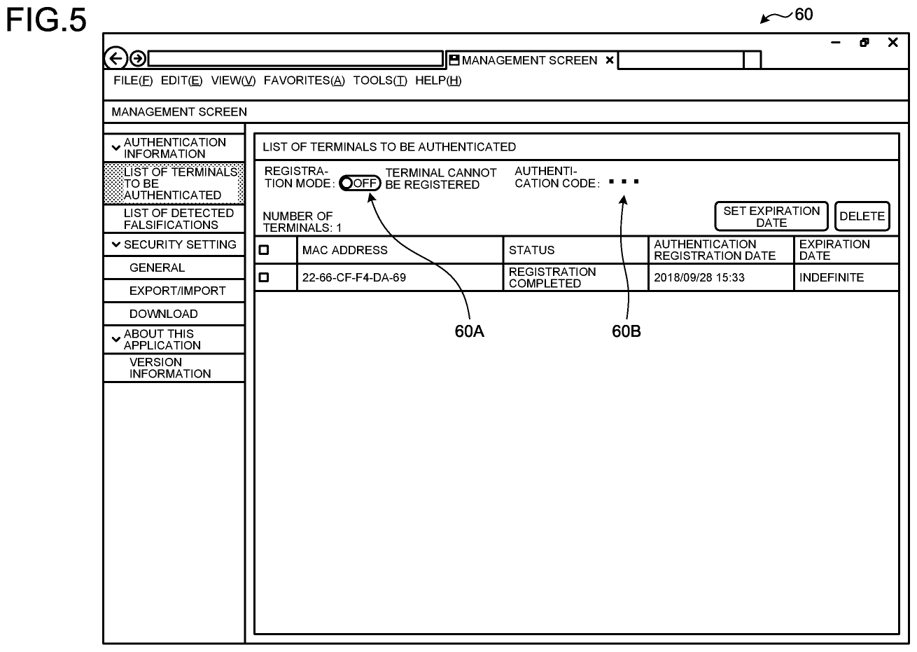

FIG. 5 is a schematic view illustrating one example of the management screen 60 when the non-registration mode is selected. The user U inputs the instruction of switching the operation mode to the non-registration mode by operating the operation mode display field 60A to select “non-registration mode”.

When the operation mode is switched to the non-registration mode, it is preferable that the display control unit 50A stops displaying the authentication code in the display field 60B on the management screen 60 and the authentication code is changed to an invisible display state.

Back to FIG. 2, the description is continued. The generation unit 50E generates the first identification information. The generation unit 50E generates the first identification information as identification information for identifying the authentication program. The generation unit 50E may generate automatically the information that can identify the authentication program in accordance with a known method. For example, the generation unit 50E may generate the first identification information using a random number generator or the like. The storage control unit 50C registers the generated first identification information in the SSID information 44A.

Moreover, the storage control unit 50C registers the first identification information generated in the generation unit 50E in the program information 44B in association with the authentication program that is identified by the first identification information.

FIG. 3C is a schematic view illustrating one example of a data structure of the program information 44B. The program information 44B stores the first identification information and the authentication program that is identified by the first identification information in association with each other.

Back to FIG. 2, the description is continued. In the present embodiment, the generation unit 50E generates the first identification information newly when the switch unit 50D has switched the operation mode from the non-registration mode to the registration mode. Then, the storage control unit 50C registers the generated first identification information in the SSID information 44A in the storage unit 44. The storage control unit 50C registers the generated first identification information in the authentication program registered in the program information 44B in the storage unit 44. Therefore, as illustrated in FIG. 3A, the first identification information and the second identification information are registered in the SSID information 44A. In addition, as illustrated in FIG. 3C, the generated first identification information is registered in association with the authentication program.

On the other hand, the storage control unit 50C deletes the first identification information from the storage unit 44 when the switch unit 50D has switched the operation mode from the registration mode to the non-registration mode. Therefore, the first identification information registered in the SSID information 44A and the program information 44B is deleted from the SSID information 44A and the program information 44B.

In this manner, the first identification information is stored in the storage unit 44 only while the operation mode of the information processing device 10 is the registration mode. Therefore, in the information processing system 1 according to the present embodiment, the authentication request process performed on the terminal device 14 side when the operation mode is the non-registration mode can be inhibited.

Next, the first distribution unit 52 is described. The first distribution unit 52 receives a first distribution request from the terminal device 14. The first distribution unit 52 receives the first distribution request from the terminal device 14 through the communication unit 46. The first distribution request includes the first identification information and the terminal identification information for the terminal device 14.

The terminal identification information is the information that can identify the terminal device 14. The terminal identification information is, for example, a physical address such as a MAC (media access control) address.

Upon the reception of the first distribution request, the first distribution unit 52 reads, from the program information 44B, the authentication program for the first identification information included in the first distribution request. Then, the first distribution unit 52 distributes the read authentication program to the terminal device 14 that is identified by the terminal identification information included in the first distribution request.

Note that the first distribution unit 52 distributes the authentication program to the terminal device 14 upon the reception of the first distribution request while the operation mode of the information processing device 10 is the registration mode. If the information expressing the current operation mode stored in the storage unit 44 expresses “registration mode” when the first distribution request is received, the first distribution unit 52 may distribute the authentication program to the terminal device 14. If the information expressing the current operation mode stored in the storage unit 44 expresses “non-registration mode” when the first distribution request is received, the first distribution unit 52 may not distribute the authentication program to the terminal device 14.

Next, the authentication control unit 54 is described. The authentication control unit 54 controls the device authentication of the terminal device 14. For example, the authentication control unit 54 performs a process about the terminal device 14 and the device authentication by working with Radius (Remote Authentication Dial In User Service) that is one example of the user authentication protocols. Note that the service used by the authentication control unit 54 is not limited to Radius.

The authentication control unit 54 includes the second distribution unit 54A, the determination unit 54B, the verification unit 54C, the registration unit 54D, the transmission control unit 54E, and the connection establishment control unit 54F.

Upon the reception of the second distribution request from the terminal device 14, the second distribution unit 54A distributes the script for displaying an input screen for the authentication code to the terminal device 14.

The second distribution request includes the second identification information for the access point 12 and the terminal identification information for the terminal device 14. The second distribution unit 54A distributes the script stored in the storage unit 44 to the terminal device 14 that is identified by the terminal identification information included in the second distribution request.

The script is the script used to display the input screen for the authentication code.

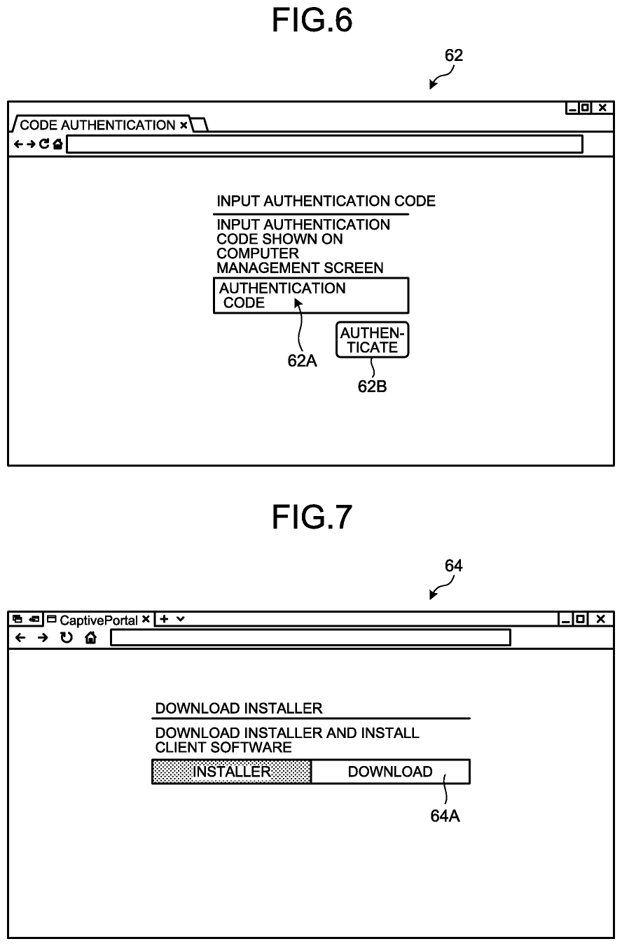

FIG. 6 is a schematic view illustrating one example of an input screen 62. The input screen 62 includes an input field 62A for inputting the authentication code therein. The input screen 62 is the screen that is displayed in the terminal device 14. The user U who operates the terminal device 14 inputs the authentication code through the input screen 62 displayed in the terminal device 14.

Back to FIG. 2, the description is continued. In the present embodiment, the second distribution unit 54A distributes the script to the terminal device 14 in accordance with the determination of the determination unit 54B. Specifically, when receiving the second distribution request, the determination unit 54B determines whether the terminal identification information included in the second distribution request is already registered in the management information 44C.

As described above, the management information 44C is the database for managing the terminal device 14 to be authenticated. That is to say, the terminal device 14 that is identified by the terminal identification information registered in the management information 44C is the terminal device 14 for which the registration process for the device authentication has been completed. On the other hand, the terminal device 14 that is identified by the terminal identification information that is not registered in the management information 44C is the terminal device 14 for which the registration process for the device authentication has not been completed.

In view of this, if the determination unit 54B has determined that the terminal identification information included in the second distribution request is not registered yet in the management information 44C, the second distribution unit 54A distributes the script to the terminal device 14. Since the second distribution unit 54A distributes the script, the terminal device 14 having received the distributed script is ready to receive the input of the authentication code through the input screen 62 (details will be described below).

Description is made below regarding the case in which the determination unit 54B has determined that the terminal identification information included in the second distribution request is already registered in the management information 44C.

Next, the verification unit 54C is described. If the terminal registration request is received from the terminal device 14 in the registration mode, the verification unit 54C verifies the authentication code.

The terminal registration request includes the terminal identification information to identify the terminal device 14, the certification information expressing a public key or a certificate, and the authentication code that is determined in advance. Regarding the certification information, a public key is used in the present embodiment as aforementioned. The authentication code is input on the terminal device 14 side through the input screen 62 displayed in the terminal device 14 because the script distributed by the second distribution unit 54A is executed on the terminal device 14 side.

The verification unit 54C verifies the authentication code by determining whether the authentication code included in the terminal registration request coincides with the authentication code stored in the storage unit 44. If the authentication code included in the terminal registration request coincides with the authentication code stored in the storage unit 44, the verification unit 54C determines that the verification has been completed successfully. On the other hand, if these authentication codes do not coincide, the verification unit 54C determines that the verification has failed.

If the verification of the authentication code by the verification unit 54C has been completed successfully, the registration unit 54D registers the terminal identification information and the certification information included in the terminal registration request in the management information 44C in association with each other. Therefore, if the verification has been completed successfully, the terminal device 14 that is identified by the terminal identification information included in the terminal registration request is registered in the management information 44C as the terminal to be authenticated for which the registration process for the device authentication has been completed.

The connection establishment control unit 54F allows the connection establishment between the access point 12 and the terminal device 14 that is identified by the terminal identification information registered in the management information 44C. For example, it is assumed that the access point 12 has received the request signal for establishing a session from the terminal device 14. In this case, the access point 12 checks whether the terminal identification information for the terminal device 14 included in the request signal is already registered in the management information 44C through the connection establishment control unit 54F. If the terminal identification information is already registered in the management information 44C, the access point 12 executes the known connection establishment process using the certification information (public key) registered in the management information 44C so as to establish the connection to the terminal device 14. Note that when the connection to the access point 12 has been established, the terminal device 14 is in connection to the network via the access point 12. The connection establishment between the terminal device 14 and the access point 12 is also referred to as session establishment.

On the other hand, in some cases, the terminal identification information included in the second distribution request is already registered in the management information 44C. That is to say, the determination unit 54B may determine that the terminal identification information included in the second distribution request is already registered in the management information 44C. In this case, the terminal device 14 that is identified by the terminal identification information is the terminal device 14 for which the registration process for the device authentication has been completed. Therefore, in this case, the second distribution unit 54A does not distribute the script.

In this case, moreover, the transmission control unit 54E transmits a response request including data that is determined in advance and a signature request for appending a signature to the data to the terminal device 14 that is identified by the terminal identification information included in the second distribution request.

As a response to the signature request, the transmission control unit 54E receives the data with signature from the terminal device 14. The transmission control unit 54E reads the public key (certification information) corresponding to the terminal identification information included in the second distribution request from the management information 44C. Then, the authentication control unit 54 authenticates the received data with signature by a known method using the read public key.

If the result of authentication by the transmission control unit 54E indicates that the authentication has been successfully performed, the connection establishment control unit 54F allows the connection to be established between the access point 12 and the terminal device 14 that is identified by the terminal identification information.

In this manner, if the second distribution request is received from the terminal device 14 that is identified by the terminal identification information that is not registered yet in the management information 44C, the authentication control unit 54 distributes the script for displaying the input screen 62 for the authentication code to the terminal device 14 and performs the process of registering the terminal device 14 in the management information 44C.

Thus, the information processing device 10 can improve the convenience of the registration process for authenticating the terminal device 14.

On the other hand, if the second distribution request is received from the terminal device 14 that is identified by the terminal identification information that is already registered in the management information 44C, the transmission control unit 54E transmits the response request including the request for appending the signature to the data to the terminal device 14. If the data with signature that is received from the terminal device 14 indicates the authentication has been successfully performed, the connection establishment control unit 54F allows the connection to the access point 12 to be established.

Therefore, the information processing device 10 can improve the convenience of the device authentication for the terminal device 14.

Next, the function of the terminal device 14 is described.

The terminal device 14 includes a control unit 20, a UI unit 22, a storage unit 24, a communication unit 26, and a communication unit 28. The UI unit 22, the storage unit 24, the communication unit 26, and the communication unit 28 are connected to the control unit 20 so that data or signals can be exchanged therebetween.

The UI unit 22 has a function of receiving the operation input from the user U, and a function of displaying an image. In the present embodiment, the UI unit 22 includes a display unit 22A and an input unit 22B. The display unit 22A displays various images. The display unit 22A is, for example, a known LCD or organic EL display.

The input unit 22B receives various operation inputs from the user U. The input unit 22B is, for example, a position input device such as a touch pad, a key board, a pointing device, a mouse, an input button, or the like. By integrating the display unit 22A and the input unit 22B formed of the touch pad, the UI unit 22 can be used as a touch panel.

The storage unit 24 stores various pieces of information. In the present embodiment, the storage unit 24 stores SSID information 24A and certification management information 24B. These pieces of information are described in detail below.

The communication unit 26 is a communication interface that wirelessly communicates with the information processing device 10 through the access point 12. The communication unit 28 is the communication interface that wirelessly communicates with the access point 12.

The control unit 20 includes a display control unit 30, a reception unit 32, an installation executing unit 34, an authentication request processing unit 36, and a communication control unit 38. The authentication request processing unit 36 includes an authentication control unit 36A, a display control unit 36B, a certificate management unit 36C, and a reception unit 36D.

These units may be achieved partially or entirely by causing a processor such as a CPU to execute a computer program, that is, by using software. Alternatively, these units may be achieved partially or entirely by using hardware such as an IC or by using software and hardware in combination.

The display control unit 30 causes displays the display unit 22A to display various kinds of information.

The reception unit 32 receives the input from the user U through the input unit 22B. The user U performs the input by operating the input unit 22B. The reception unit 32 receives from the input unit 22B, signals or information that is input by the operation input from the user U with the input unit 22B.

The installation executing unit 34 installs the authentication program in the terminal device 14 upon the reception of the input of the first identification information. The installation executing unit 34 uses, for example, the captive portal function of the access point 12 and upon the reception of the input of the first identification information, redirects to the download site of the authentication program, thereby installing the authentication program.

Specifically, the reception unit 32 receives the input of the first identification information from the input unit 22B. The display control unit 30 reads a list of SSIDs (first identification information, second identification information) included in periodic transmission signals that are transmitted from the access point 12, and causes the display unit 22A to display the list. The user U selects the first identification information that is desired, by operating the input unit 22B with reference to the display unit 22A. By this operation, the reception unit 32 receives the selected first identification information from the input unit 22B.

Then, the display control unit 30 causes the display unit 22A to display a display screen 64 that induces the user U to download and install the authentication program by the captive portal function of the access point 12, for example. FIG. 7 is a schematic view illustrating one example of the display screen 64. For example, the user U operates the input unit 22B so as to operate and instruct a display area 64A in the display screen 64 in order to instruct the user U to download. By this operation, the reception unit 32 receives the instruction of downloading.

Back to FIG. 2, the description is continued. Upon the reception of the instruction of the downloading, the installation executing unit 34 transmits the first distribution request including the received first identification information and the terminal identification information for the terminal device 14, to the information processing device 10 through the communication unit 26.

As described above, the information processing device 10 having received the first distribution request distributes the authentication program identified by the first identification information included in the first distribution request to the terminal device 14. When the operation mode is switched to the registration mode, the information processing device 10 may enable the captive portal function, and when the operation mode is switched to the non-registration mode, the information processing device 10 may disable the captive portal function. Then, the terminal management unit 50 may register the first identification information in the SSID information 44A, and register the download site of the authentication program in the first identification information. The screen of the download site of the authentication program is, for example, the display screen 64 illustrated in FIG. 7. Then, the installation executing unit 34 of the terminal device 14 receives (downloads) the authentication program from the information processing device 10.

The installation executing unit 34 installs the authentication program in the terminal device 14. When the authentication program has been installed, the authentication request processing unit 36 is constructed in the control unit 20.

The authentication request processing unit 36 is a function unit for performing the authentication request process for the access point 12 in the terminal device 14. The authentication request process is the process for transmitting at least one of the second distribution request and the terminal registration request to the information processing device 10.

The authentication request processing unit 36 performs the authentication request process without using a password. For example, the authentication request processing unit 36 is the function unit that communicates with the information processing device 10 with the communication protocol using the authentication method “FIDO (Fast IDentity Online)”.

In the present embodiment, the authentication request processing unit 36 includes the authentication control unit 36A, the display control unit 36B, the certificate management unit 36C, and the reception unit 36D.

The authentication control unit 36A, upon receiving the input of the authentication code and the second identification information for the access point 12, transmits the terminal registration request to the information processing device 10.

Specifically, the display control unit 36B reads the SSID information 24A that is updated using the SSID (first identification information, second identification information) included in the periodic transmission signals transmitted from the access point 12.

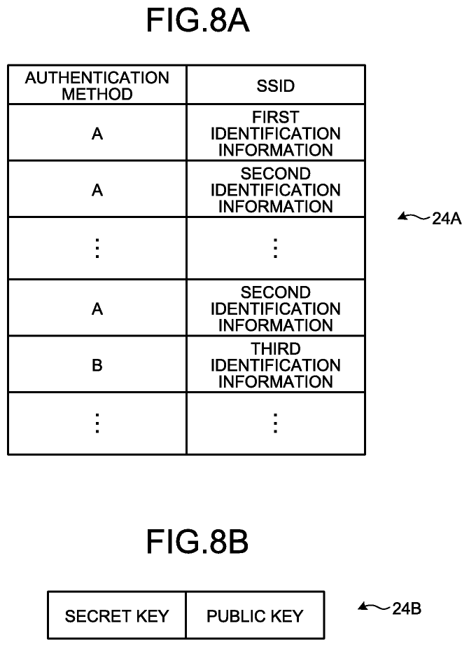

FIG. 8A is a schematic view illustrating one example of the data structure of the SSID information 24A. The SSID information 24A is the information in which the authentication method and the SSID are associated with each other. In the SSID information 24A, the SSIDs (identification information), for example, the first identification information, the second identification information, and the third identification information, and the authentication method are associated with each other and registered.

The authentication method is the authentication method used for the wireless communication between the terminal device 14 and the information processing device 10. The authentication method is, for example, “FIDO” that is the authentication method used by the authentication request processing unit 36 or an authentication method other than FIDO (for example, authentication method determined depending on the operating system (OS)). FIG. 8A illustrates one example in which the authentication method “A” is the authentication method “FIDO” and the authentication method “B” is the authentication method other than FIDO.

The authentication method “A” is one example of the authentication method that the authentication request processing unit 36 constructed by the installation by the installation executing unit 34 uses when wirelessly communicating with the information processing device 10 as described above.

The third identification information is the SSID used when the wireless communication is performed using the authentication method other than FIDO. That is to say, the authentication method “B” for the third identification information is the authentication method different from the authentication method that the authentication request processing unit 36 uses when wirelessly communicating with the information processing device 10.

Back to FIG. 2, the description is continued. When receiving the selection of the second identification information by the user U, the display control unit 36B causes the display unit 22A to display a list of SSIDs for the authentication method used by the authentication request processing unit 36. Specifically, the authentication request processing unit 36 causes the display unit 22A to display a list of SSIDs (first identification information, second identification information) for the authentication method “B” expressing FIDO that is the authentication method used by the authentication request processing unit 36 among the SSIDs registered in the SSID information 24A. The user U selects the desired second identification information by operating the input unit 22B with reference to the display unit 22A. Then, the authentication control unit 36A transmits the second distribution request including the received second identification information and the terminal identification information, to the information processing device 10 through the communication unit 26.

As a response to the second distribution request, the authentication control unit 36A receives the script from the information processing device 10. In this case, the display control unit 36B causes the display unit 22A to display the input screen 62 by executing the received script (see FIG. 6). That is to say, the display control unit 36B causes the display unit 22A to display the input screen 62 for the authentication code upon the reception of the input of the second identification information.

The user U inputs the authentication code to the input field 62A in the input screen 62 by operating the input unit 22B with reference to the input screen 62. As described above, in the present embodiment, it is assumed that the user U such as an administrator operates the information processing device 10 and the terminal devices 14 to perform the process about the registration for authenticating the terminal device 14. Therefore, the user U only needs to see the authentication code displayed in the management screen 60 (see FIG. 4) displayed in the display unit 42A of the information processing device 10, and operate the input unit 22B of the terminal device 14, thereby inputting the authentication code in the input field 62A in the input screen 62 (see FIG. 6). Then, the user U selects the display area of an authentication button 62B in the input screen 62 (see FIG. 6).

Then, the authentication control unit 36A receives the input of the authentication code through the input screen 62. That is to say, the authentication control unit 36A receives the authentication code from the input unit 22B. Upon the reception of the authentication code in the authentication control unit 36A, the certificate management unit 36C generates the certification information used in the wireless communication with the access point 12. In the present embodiment, the certificate management unit 36C generates a pair of a public key and a secret key using a known method. Then, the certificate management unit 36C stores the certification management information 24B including the pair of the public key and the secret key in the storage unit 24.

FIG. 8B is a schematic view illustrating one example of the certification management information 24B. For example, as illustrated in FIG. 8B, a public key and a secret key generated by the authentication control unit 36A are registered in the certification management information 24B in association with each other.

Back to FIG. 2, the description is continued. The authentication control unit 36A transmits to the information processing device 10, the terminal registration request including the authentication code, the input of which has been received, the generated public key (that is, certification information), and the terminal identification information for the terminal device 14.

By the transmission of the terminal registration request to the information processing device 10, a registration process for the device authentication on the information processing device 10, that is, the registration process of registering the terminal identification information in the management information 44C is performed as described above.

That is to say, by the reception of the input of the first identification information corresponding to one example of the SSID of the access point 12 from the user U, the authentication program for performing the authentication request process is installed in the terminal device 14 and the authentication request processing unit 36 is constructed in the terminal device 14. Additionally, in the terminal device 14, by the reception of the input of the second identification information corresponding to another example of the SSID of the access point 12 from the user U, the terminal registration request is transmitted from the authentication request processing unit 36 to the information processing device 10 and is registered in the management information 44C on the information processing device 10 side.

Thus, just by the operation of the user U of inputting the first identification information and the second identification information to the terminal device 14, the terminal device 14 is registered in the management information 44C through the process between the terminal device 14 and the information processing device 10. Therefore, the information processing device 10 according to the present embodiment can improve the convenience of the device authentication.

Note that a plurality of pieces of the second identification information can be set for the access point 12. Therefore, it is preferable that the reception unit 36D and the authentication control unit 36A of the terminal device 14 perform the following process regularly.

Specifically, the reception unit 36D receives periodic transmission signals including the SSID of the access point 12 (that is, the second identification information) from one or a plurality of access points 12 capable of wireless communication. The reception unit 36D receives the periodic transmission signals transmitted periodically from the access point or access points 12.

The authentication control unit 36A determines whether the received periodic transmission signal is a signal applicable in a predetermined authentication method. The predetermined authentication method is the authentication method that the authentication request processing unit 36 that is constructed by the installation by the installation executing unit 34 uses to wirelessly communicate with the information processing device 10. As described above, in the present embodiment, the authentication request processing unit 36 performs the wireless communication with the use of the communication protocol based on the authentication method “FIDO”. Therefore, in the present embodiment, the authentication control unit 36A determines whether the periodic transmission signal is the signal of the communication protocol using the authentication method “FIDO”.

If the received periodic transmission signal is applicable in the predetermined authentication method, the authentication control unit 36A causes the SSID included in the period signal to be stored in the SSID information 24A as the second identification information used in the connection to the access point 12 to be a subject of the wireless communication. Specifically, the authentication control unit 36A registers the SSID in the SSID information 24A as the second identification information while associating the SSID with “A” expressing the authentication method “FIDO” (see FIG. 8A).

On the other hand, if the received periodic transmission signal is not applicable in the predetermined authentication method, the authentication control unit 36A determines whether the SSID included in the periodic transmission signal is already stored in the SSID information 24A as the second identification information. If the SSID is already stored in the SSID information 24A as the second identification information, the authentication control unit 36A cancels the storage of the SSID as the second identification information. Specifically, the authentication control unit 36A changes the registration content of the SSID information 24A so that the SSID is registered in the SSID information 24A as the third identification information in association with “B” expressing the authentication method other than “FIDO.” Note that the authentication control unit 36A may cancel the storage of the SSID as the second identification information by deleting the information of the authentication method for the SSID in the SSID information 24A.

Here, as described above, when receiving the selection of the second identification information by the user U, the display control unit 36B of the authentication request processing unit 36 causes the display unit 22A to display a list of SSIDs for the authentication method employed by the authentication request processing unit 36. Specifically, the authentication request processing unit 36 causes the display unit 22A to display a list of SSIDs (first identification information, second identification information) for “B” expressing FIDO that is the authentication method employed by the authentication request processing unit 36 among the SSIDs registered in the SSID information 24A so that the user can select the SSID.

Therefore, the authentication control unit 36A updates the SSID information 24A in accordance with the received periodic transmission signal; thus, the authentication request processing unit 36 can update easily and fast the list of SSIDs used in the wireless communication without requiring a manual update operation by the user U. That is to say, the workload of the user U can be reduced. In addition, even in a case where another piece of second identification information is set for the access point 12, the authentication control unit 36A can cause the display unit 22A to display easily and fast a list of latest SSIDs used in the wireless communication in the authentication request processing unit 36.

Next, one example of the procedure of the information processing to be performed by the information processing system 1 according to the present embodiment is described.

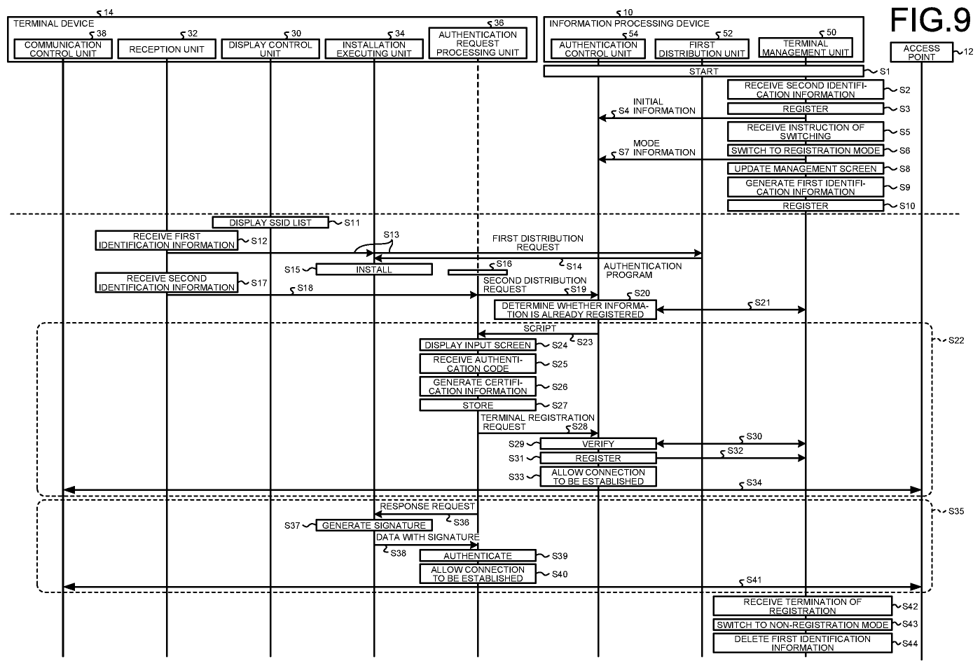

FIG. 9 is a sequence diagram illustrating one example of the procedure of the information processing to be performed by the information processing system 1 according to the present embodiment.

The operation of the user U on a power button for supplying power to the information processing device 10 causes the information processing device 10 to start the terminal management unit 50, the first distribution unit 52, and the authentication control unit 54 (step S1).

Next, the user U inputs the second identification information by operating the input unit 42B. Then, the reception unit 50B receives the input of the second identification information (step S2). The storage control unit 50C registers the second identification information received at step S2 in the SSID information 44A in the storage unit 44 (step S3). Then, the storage control unit 50C notifies the information expressing the script that is identified by the second identification information received at step S2 to the authentication control unit 54 as the initial information (step S4). Therefore, the information expressing the input screen 62 in which the second identification information of the script has been enabled is notified to the authentication control unit 54.

Next, the switch unit 50D receives the instruction of switching the mode from the non-registration mode to the registration mode (step S5). Specifically, the display control unit 50A causes the display unit 42A to display the management screen 60 (see FIG. 4). The user U inputs the instruction of switching the mode to the registration mode by operating the operation mode display field 60A in the management screen 60 to select “registration mode”.

The switch unit 50D having received the instruction of switching the mode to the registration mode from the input unit 42B switches the operation mode from the non-registration mode to the registration mode (step S6). Therefore, the information processing device 10 is ready to perform the registration in the management information 44C.

Next, the switch unit 50D outputs to the authentication control unit 54, the mode information including the information expressing that the mode has been switched to the registration mode and the authentication code (step S7). The authentication code may be stored in the storage unit 44 in advance. Then, the switch unit 50D may output the authentication code read from the storage unit 44 to the authentication control unit 54.

Next, the display control unit 50A updates the management screen 60 displayed in the display unit 42A in the process at step S5, and causes the display unit 42A to display the authentication code output at step S7 in the management screen 60 (step S8). Thus, as illustrated in FIG. 4, the display field 60B in the management screen 60 displays the authentication code.

Next, the generation unit 50E generates the first identification information (step S9). The generation unit 50E automatically generates the information that can identify the authentication program in accordance with a known method. The storage control unit 50C registers the first identification information generated at step S9 in the SSID information 44A (step S10). Therefore, the periodic transmission signal transmitted from the access point 12 includes the first identification information registered newly at step S10 and the second identification information registered newly at step S3.

On the other hand, the display control unit 30 of the terminal device 14 causes the display unit 22A to display a list of SSIDs registered in the SSID information 24A updated in accordance with the periodic transmission signals transmitted from the access point 12 (step S11). The user U selects the desired first identification information from among the list of SSIDs that are displayed. By this operation, the reception unit 32 receives the selected first identification information from the input unit 22B (step S12).

The display control unit 30 causes the display unit 22A to display the display screen 64 that induces the user U to download and install the authentication program (see FIG. 7). The user U operates and instructs the display area 64A to instruct to execute the downloading in the display screen 64 by operating the input unit 22B. By this operation, the reception unit 32 receives the instruction of executing the downloading. Upon the reception of the instruction of executing the downloading, the installation executing unit 34 transmits the first distribution request including the received first identification information and the terminal identification information for the terminal device 14, to the information processing device 10 through the communication unit 26 (step S13).

The first distribution unit 52 of the information processing device 10, upon the reception of the first distribution request, reads the authentication program for the first identification information included in the first distribution request from the program information 44B. Then, the first distribution unit 52 distributes the read authentication program to the terminal device 14 (step S14).

The installation executing unit 34 of the terminal device 14 installs the authentication program received from the information processing device 10 in the terminal device 14 (step S15). When the authentication program has been installed, the authentication request processing unit 36 is constructed in the control unit 20 of the terminal device 14 (step S16).

Next, the display control unit 36B of the authentication request processing unit 36 causes the display unit 22A to display a list of SSIDs for the authentication method employed by the authentication request processing unit 36. Specifically, the authentication request processing unit 36 causes the display unit 22A to display a list of SSIDs for “B” expressing FIDO that is the authentication method employed by the authentication request processing unit 36 among the SSIDs registered in the SSID information 24A so that the user can select the SSID.

The user U selects the desired second identification information from a list of SSIDs displayed in the display unit 22A by operating the input unit 22B. By this operation, the reception unit 32 receives the second identification information (step S17) and outputs the second identification information to the authentication request processing unit 36 (step S18).

The authentication control unit 36A of the authentication request processing unit 36 transmits the second distribution request including the second identification information received at step S17 and the terminal identification information for the terminal device 14, to the information processing device 10 through the communication unit 26 (step S19).

Upon the reception of the second distribution request, the determination unit 54B of the authentication control unit 54 in the information processing device 10 determines whether the terminal identification information included in the second distribution request is already registered in the management information 44C (step S20, step S21).

If it is determined that the terminal identification information is not registered yet, the authentication control unit 54 performs the process of step S22 between the terminal device 14 and the information processing device 10. On the other hand, if it is determined that the terminal identification information is already registered, the authentication control unit 54 performs the process of step S35 between the terminal device 14 and the information processing device 10.

First, the process of step S22 is described. The process of step S22 includes step S23 to step S34.

If the determination unit 54B has determined that the terminal identification information included in the second distribution request is not registered yet in the management information 44C at step S20, the second distribution unit 54A of the authentication control unit 54 distributes the script for displaying the input screen 62 for the authentication code to the terminal device 14 (step S23).

The display control unit 36B of the authentication request processing unit 36 in the terminal device 14 causes the display unit 22A to display the input screen 62 (see FIG. 6) (step S24). The user U inputs the authentication code in the input field 62A of the input screen 62 by operating the input unit 22B with reference to the input screen 62. The user U only needs to see the authentication code displayed in the management screen 60 (see FIG. 4) displayed in the display unit 42A of the information processing device 10 at step S8, and operate the input unit 22B of the terminal device 14, thereby inputting the authentication code. Next, the user U selects the display area of the authentication button 62B in the input screen 62.

Then, the authentication control unit 36A receives the input of the authentication code (step S25). The certificate management unit 36C generates the certification information to be used in the wireless communication with the access point 12 (step S26). In the present embodiment, the certificate management unit 36C generates a pair of a public key and a secret key by a known method. Then, the certificate management unit 36C stores the certification management information 24B including the pair of the public key and the secret key in the storage unit 24 (step S27).

Next, the authentication control unit 36A transmits the terminal registration request including the authentication code, the input of which has been received at step S25, the public key generated at step S26, and the terminal identification information for the terminal device 14, to the information processing device 10 (step S28).

In the information processing device 10, the verification unit 54C of the authentication control unit 54 determines whether the authentication code included in the terminal registration request received at step S28 coincides with the authentication code stored in the storage unit 44, thereby verifying the authentication code (step S29, step S30). Here, it is assumed that the verification has been completed successfully and the description is continued.

Next, if the authentication code has been verified successfully by the verification unit 54C, the registration unit 54D of the authentication control unit 54 registers, in the management information 44C, the terminal identification information and the certification information included in the terminal registration request received at step S28 in association with each other (step S31, step S32). Therefore, if the verification has been completed successfully, the terminal device 14 that is identified by the terminal identification information included in the terminal registration request received at step S28 is registered in the management information 44C as the terminal to be authenticated.

Then, the connection establishment control unit 54F of the authentication control unit 54 allows the connection to be established between the access point 12 and the terminal device 14 that is identified by the terminal identification information registered in the management information 44C (step S33). Therefore, if the request signal for establishing the session is received from the terminal device 14, the access point 12 is ready to establish the session (step S34).

On the other hand, if the determination unit 54B of the authentication control unit 54 has determined that the terminal identification information is already registered at step S20, the authentication control unit 54 performs the process of step S35 between the terminal device 14 and the information processing device 10. The process of step S35 includes steps S36 to S41.

The transmission control unit 54E of the authentication control unit 54 transmits the response request including the data determined in advance and the signature request for appending the signature to the data to the terminal device 14 that is identified by the terminal identification information included in the second distribution request received at step S19 (step S36).

The certificate management unit 36C of the authentication request processing unit 36 in the terminal device 14 generates the signature using the received data, and the public key and the secret key that are registered in the certification management information 24B (step S37). Then, the authentication control unit 36A of the authentication request processing unit 36 transmits the data with signature to the information processing device 10 (step S38).

The transmission control unit 54E of the authentication control unit 54 in the information processing device 10 authenticates the data with signature received from the terminal device 14 by a known method using the certification information for the terminal identification information (step S39).

If the authentication result at step S39 indicates that the authentication has been successfully performed, the connection establishment control unit 54F of the authentication control unit 54 allows the connection to be established between the access point 12 and the terminal device 14 that is identified by the terminal identification information (step S40). Therefore, the access point 12 having received the request signal for establishing the session from the terminal device 14 is ready to establish the session (step S41).

Next, the reception unit 50B of the information processing device 10 receives the instruction of terminating the registration process (step S42). In the case of terminating the registration process of the terminal device 14 for the device authentication, the user U inputs the signal expressing the end of registration by operating the input unit 42B. By receiving this signal, the reception unit 50B receives the instruction of terminating the registration process.

Then, the switch unit 50D of the terminal management unit 50 switches the operation mode from the registration mode to the non-registration mode (step S43). Then, the storage control unit 50C of the terminal management unit 50 deletes the first identification information registered in the storage unit 44 at step S9 from the storage unit 44 (step S44). Therefore, the first identification information that is registered in the SSID information 44A and the program information 44B is deleted from the SSID information 44A and the program information 44B. Then, this sequence is terminated.

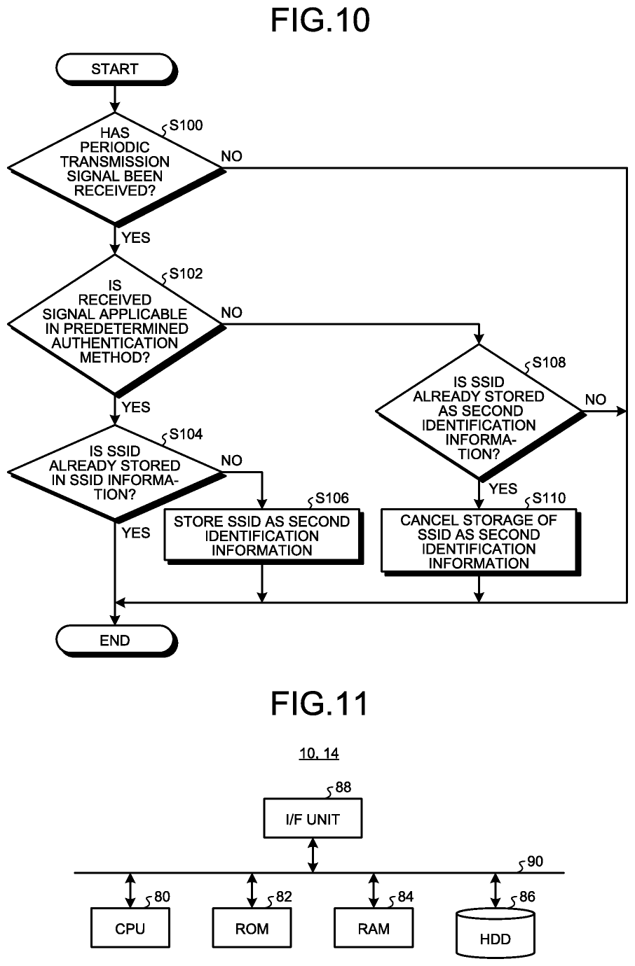

Next, an interruption process to be performed by the terminal device 14 is described. The authentication request processing unit 36 of the terminal device 14 performs the interruption process illustrated in FIG. 10 at predetermined time intervals.

FIG. 10 is a flowchart illustrating one example of the interruption process to be performed by the authentication request processing unit 36 in the terminal device 14.

First, the reception unit 36D of the authentication request processing unit 36 determines whether the periodic transmission signal has been received from the access point 12 (step S100). If the periodic transmission signal has not been received from the access point 12 (No at step S100), this routine is terminated. If the periodic transmission signal has been received from the access point 12 (Yes at step S100), the process advances to step S102.

At step S102, the authentication control unit 36A determines whether the periodic transmission signal received at step S100 is the signal applicable in the authentication method that is determined in advance (step S102). Specifically, the authentication control unit 36A determines whether the periodic transmission signal is a signal applicable to the communication protocol using the authentication method that the authentication request processing unit 36 uses to wirelessly communicate with the information processing device 10. In the present embodiment, the authentication control unit 36A determines whether the periodic transmission signal is the signal applicable to the communication protocol using the authentication method “FIDO”.

If it is determined that the periodic transmission signal received at step S100 is applicable in the authentication method that is determined in advance (Yes at step S102), the process advances to step S104. At step S104, the authentication control unit 36A determines whether the SSID included in the periodic transmission signal received at step S100 is already stored in the SSID information 24A (step S104). If the SSID is already stored (Yes at step S104), this routine is terminated. If the SSID is not stored yet in the SSID information 24A (No at step S104), the process advances to step S106.

At step S106, the authentication control unit 36A stores the SSID included in the periodic transmission signal received at step S100 in the SSID information 24A as the second identification information used in the connection to the access point 12 that is a subject of the wireless communication (step S106). More specifically, the authentication control unit 36A registers the SSID in the SSID information 24A as the second identification information in association with “A” expressing the authentication method “FIDO” (see FIG. 8A). Then, this routine is terminated.

On the other hand, if the authentication control unit 36A has determined that the periodic transmission signal received at step S100 is not the signal applicable in the authentication method that is determined in advance (No at step S102), the process advances to step S108.

At step S108, the authentication control unit 36A determines whether the SSID included in the periodic transmission signal is already stored in the SSID information 24A as the second identification information (step S108). The authentication control unit 36A performs the determination at step S108 by determining whether the SSID included in the periodic transmission signal is already registered in the SSID information 24A in association with “A” expressing the authentication method “FIDO”.

If the SSID is not stored in the SSID information 24A as the second identification information (No at step S108), this routine is terminated.

On the other hand, if the SSID is already stored in the SSID information 24A as the second identification information (Yes at step S108), the authentication control unit 36A cancels the storage of the SSID as the second identification information (step S110). Specifically, the authentication control unit 36A changes the registration content of the SSID information 24A so that the SSID is registered in the SSID information 24A as the third identification information in association with “B” expressing the authentication method other than “FIDO”. Then, this routine is terminated.

As described above, the information processing device 10 according to the present embodiment includes the switch unit 50D, the verification unit 54C, and the registration unit 54D. The switch unit 50D switches the operation mode between the registration mode in which the registration process for registering in the management information 44C to manage the terminals to be authenticated can be performed, and the non-registration mode in which the registration process cannot be performed. If the terminal registration request including the terminal identification information that identifies the terminal device 14, the certification information expressing the public key or the certificate, and the authentication code that is determined in advance is received from the terminal device 14 in the registration mode, the verification unit 54C performs the verification of the authentication code. If the authentication code has been verified successfully, the registration unit 54D registers, in the management information 44C, the terminal identification information and the certification information included in the terminal registration request in association with each other.

In the present embodiment, upon the reception of the terminal registration request including the terminal identification information for the terminal device 14, the certification information, and the authentication code in the registration mode, if the authentication code has been verified successfully, the information processing device 10 registers, in the management information 44C, the certification information and the terminal identification information in association with each other and registers these pieces of information. The management information 44C is the information used to manage the terminal to be authenticated.

Therefore, by receiving the terminal registration request in the registration mode, the information processing device 10 according to the present embodiment manages the terminal device 14, which is identified by the terminal identification information included in the terminal registration request, as the terminal device 14 for which the registration process for the device authentication has been completed. That is to say, the information processing device 10 according to the present embodiment can perform the registration process for the device authentication without distributing the dedicated computer program or the certificate to the terminal device 14 to be authenticated through a portable medium such as a universal serial bus (USB) memory or email, for example.

In addition, the terminal device 14 according to the present embodiment includes the reception unit 32 and the authentication control unit 36A. The reception unit 32 receives the input from the user U. Upon the reception of the input of the authentication code that is determined in advance and the second identification information for the access point 12, the authentication control unit 36A transmits to the information processing device 10, the terminal registration request including the received authentication code, the certification information expressing the certificate or the public key used in the wireless communication with the access point 12, and the terminal identification information for the terminal device 14.

Therefore, the user U who operates the terminal device 14 only needs to input the second identification information and the authentication code in order to transmit the terminal registration request to the information processing device 10.

That is to say, the terminal device 14 according to the present embodiment can perform the registration process for the device authentication by input of the second identification information and the authentication code without requiring the installation of the distributed dedicated computer program or the registration of the certificate.

In the conventional technique, on the other hand, the certificate or the computer program issued by the authentication server has been distributed to the user through the portable medium such as a USB memory or through email or the like. Then, the user has installed the distributed computer program manually in the terminal device and next, registered the terminal device in the authenticating server. Therefore, as more terminals are to be registered for the device authentication, the operation becomes more complicated. Specifically, for example, it is assumed that one terminal device is distributed to each of 40 students in the class. In this case, it requires large workload to register the terminal devices 14. Specifically, if the terminal device is distributed to each of 40 students in 20 classes, 800 terminal devices in total need to be registered.

On the other hand, the information processing system 1, the information processing device 10, and the terminal device 14 according to the present embodiment only need the input of the second identification information and the authentication code in the terminal device 14 by the user U in order to register the terminal device 14 for the device authentication on the information processing device 10 side.

Therefore, in the information processing system 1, the information processing device 10, and the terminal device 14 according to the present embodiment can improve the convenience of the device authentication.

In the information processing device 10 and the terminal device 14 according to the present embodiment, it is unnecessary to distribute the certificate or the computer program issued by the authenticating server to the user through the portable medium such as a USB memory, email, or the like; therefore, the risk of theft or impersonation can be reduced. Thus, the information processing device 10 and the terminal device 14 according to the present embodiment can improve the convenience of the device authentication and the security.

The information processing program according to the present embodiment can improve the convenience of the device authentication similarly to the information processing device 10.

The information processing device 10 includes the first distribution unit 52. Upon the reception, from the terminal device 14, of the first distribution request including the first identification information that identifies the authentication program for performing the authentication request process for the access point 12 in the terminal device 14, the first distribution unit 52 distributes the authentication program identified by the first identification information to the terminal device 14. By such a structure, the authentication program is distributed to the terminal device 14 upon the reception of the first distribution request; therefore, the device authentication can be more convenient.

In addition, the information processing device 10 includes the storage control unit 50C. The storage control unit 50C stores the newly generated first identification information in the storage unit 44 when the non-registration mode has been switched to the registration mode. In addition, when the registration mode has been switched to the non-registration mode, the storage control unit 50C deletes the first identification information from the storage unit 44. By such a structure, the first identification information is stored in the storage unit 44 only in the period of the registration mode; therefore, the distribution of the authentication program in the non-registration mode can be reduced.

The information processing device 10 moreover includes the second distribution unit 54A. Upon the reception, from the terminal device 14, of the second distribution request including the terminal identification information and the second identification information for the access point 12, the second distribution unit 54A distributes the script for displaying the input screen 62 for the authentication code to the terminal device 14 that is identified by the terminal identification information. If the terminal registration request including the terminal identification information, the certification information, and the authentication code that is input through the input screen 62 displayed in the terminal device 14 is received from the terminal device 14 in the registration mode, the verification unit 54C performs the verification of the authentication code. By such a structure, the script for displaying the input screen for the authentication code is distributed to the terminal device upon the reception of the second distribution request; therefore, the security and the convenience of the device authentication can be improved.

Moreover, the information processing device 10 includes the determination unit 54B, the transmission control unit 54E, and the communication establishment control unit 54F. Upon the reception of the second distribution request from the terminal device 14, the determination unit 54B determines whether the terminal identification information included in the second distribution request is already registered in the management information 44C. If it is determined that the request is already registered, the transmission control unit 54E transmits the response request including the data that is determined in advance and the request for appending the signature to the data to the terminal device 14 that is identified by the terminal identification information. Upon the reception of the data with signature from the terminal device 14, if the result of authenticating the data with signature with the use of the certification information for the terminal identification information indicates that the authentication has been successfully performed, the connection establishment control unit 54F allows the connection to be established between the terminal device 14 and the access point 12. By such a structure, if the terminal identification information is already registered and the result of authenticating the data with signature received from the terminal device 14 indicates that the authentication has been successfully performed, the establishment of the connection between the terminal device 14 and the access point 12 is allowed. Therefore, since the establishment of the connection is allowed without distributing the script if the terminal identification information is already registered in the management information 44C, the device authentication can be more convenient.

The terminal device 14 includes the display control unit 36B. The display control unit 36B performs the display of the input screen 62 for the authentication code upon the reception of the second identification information. Upon the reception of the input of the authentication code through the input screen 62, the authentication control unit 36A transmits the terminal registration request including the received authentication code, the certification information, and the terminal identification information to the information processing device 10. By such a structure, the terminal registration request is transmitted to the information processing device 10 upon the reception of the authentication code through the input screen 62 that is displayed when the second identification information is received; therefore, the operation can be reduced and the device authentication can be more convenient.

The terminal device 14 includes the installation executing unit 34. Upon the reception of the input of the first identification information that identifies the authentication program in order to perform the authentication request process for the access point 12 in the terminal device 14, the installation executing unit 34 installs the authentication program in the terminal device 14. By such a structure, the authentication program is installed upon the reception of the input of the first identification information; therefore, the operation can be reduced and the device authentication can be more convenient.

The terminal device 14 includes the reception unit 36D. The reception unit 36D receives the periodic transmission signal including the identification information for the access point 12 from one or more access points 12 capable of wireless communication. If the received periodic transmission signal is applicable in the predetermined authentication method, the authentication control unit 36A stores the identification information as the second identification information that is used to connect with the access point 12 to be the subject of the wireless communication. By such a structure, if the periodic transmission signal is applicable in the predetermined authentication method, the identification information included in the periodic transmission signal is stored as the second identification information; therefore, the manual update of the second identification is unnecessary and thus, the updating work can be made efficient and the convenience can be improved.

Hardware Structure

Next, one example of a hardware structure of the information processing device 10 and the terminal device 14 according to the above embodiment is described. FIG. 11 is a diagram illustrating one example of the hardware structure diagram of the information processing device 10 and the terminal device 14.

The information processing device 10 and the terminal device 14 have a hardware structure including a general computer including a control device such as a CPU 80, a storage device such as a ROM (Read Only Memory) 82, a RAM (Random Access Memory) 84, and an HDD (Hard Disk Drive) 86, an I/F unit 88 corresponding to an interface to various devices, and a bus 90 that connects between these units.

In the information processing device 10 and the terminal device 14, the aforementioned units are achieved in the computer as the CPU 80 reads a computer program from the ROM 82 to the RAM 84 and executes the computer program.

Note that the computer program to perform each process to be executed in the information processing device 10 and the terminal device 14 may be stored in the HDD 86. The computer program to perform each process to be executed in the information processing device 10 and the terminal device 14 may be incorporated in advance in the ROM 82 and provided.

The computer program to perform each process to be executed in the information processing device 10 and the terminal device 14 may be stored in a computer readable storage medium such as a CD-ROM, a CD-R, a memory card, a digital versatile disc (DVD), or a flexible disk (FD) in an installable or executable format, and provided as a computer program product. The computer program to perform each process to be executed in the information processing device 10 and the terminal device 14 may be stored in a computer connected to a network such as the Internet and downloaded via the network. The computer program to perform each process to be executed in the information processing device 10 and the terminal device 14 may be provided or distributed through the network such as the Internet.

According to an aspect of the present disclosure, the device authentication can be more convenient.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
processing circuitry that implements:
a switch unit that switches between a registration mode in which execution of registration in management information to manage a terminal to be authenticated is enabled and a non-registration mode in which execution of the registration is disabled;
a verification unit that, in response to receiving a terminal registration request including terminal identification information that identifies a terminal device, certification information expressing a public key or a certificate, and an authentication code that is determined in advance from the terminal device in the registration mode, verifies the authentication code; and
a registration unit that, in response to the authentication code being verified successfully, registers the certification information and the terminal identification information included in the terminal registration request in associate with each other in the management information.

2. The information processing device according to claim 1, wherein the processing circuitry further implements a first distribution unit that, in response to receiving a first distribution request including first identification information that identifies an authentication program for performing an authentication request process for an access point in the terminal device from the terminal device, distributes the authentication program that is identified by the first identification information to the terminal device.

3. The information processing device according to claim 2, wherein the processing circuitry further implements a storage control unit that stores the first identification information generated newly in a storage unit in response to the non-registration mode being switched to the registration mode, and deletes the first identification information from the storage unit in response to the registration mode being switched to the non-registration mode.

4. The information processing device according to claim 2, wherein
the processing circuitry further implements a second distribution unit that, in response to receiving a second distribution request including second identification information for the access point and the terminal identification information from the terminal device, distributes a script for displaying an input screen for the authentication code to the terminal device that is identified by the terminal identification information, and
the verification unit verifies the authentication code in response to receiving from the terminal device: the terminal registration request including the terminal identification information, the certification information, and the authentication code that is input through the input screen displayed in the terminal device in the registration mode.

5. The information processing device according to claim 4, wherein the processing circuitry further implements:
a determination unit that, in response to receiving the second distribution request from the terminal device, determines whether the terminal identification information included in the second distribution request is already registered in the management information;
a transmission control unit that, in response to a determination that the terminal identification information is already registered, transmits a response request including data that is determined in advance and a request for appending a signature to the data to the terminal device that is identified by the terminal identification information; and
a connection establishment control unit that, in response to receiving the data with the signature from the terminal device, allows connection to be established between the terminal device and the access point when a result of authenticating the data with the signature using the certification information corresponding to the terminal identification information indicates that the authentication has been successfully performed.

6. A terminal device comprising:
processing circuitry that implements
a reception unit that receives input from a user; and
an authentication control unit that, in response to receiving input of second identification information for an access point and an authentication code that is determined in advance, transmits: a terminal registration request including the received authentication code, certification information expressing a public key or a certificate that is used in wireless communication with the access point, and terminal identification information for the terminal device to an information processing device.

7. The terminal device according to claim 6, wherein
the processing circuitry further implements a display control unit that displays an input screen for the authentication code in response to receiving the second identification information, and
in response to receiving input of the authentication code through the input screen, the authentication control unit transmits the terminal registration request including the received authentication code, the certification information, and the terminal identification information to the information processing device.

8. The terminal device according to claim 6, wherein the processing circuitry further implements an installation executing unit that, in response to receiving input of first identification information that identifies an authentication program for performing an authentication request process for the access point in the terminal device, installs the authentication program in the terminal device.

9. The terminal device according to claim 6, wherein
the access point includes one or more access points capable of wireless communication,
the processing circuitry further implements a reception unit that receives, from the one or more access points, a periodic transmission signal including identification information for the one or more access points, and
when the received periodic transmission signal is applicable in an authentication method that is determined in advance, the authentication control unit stores the identification information as the second identification information used to connect to the access point that is a subject of wireless communication.

10. An information processing system comprising:
a terminal device; and
the information processing device according to claim 1,
the terminal device comprising:
processing circuitry that implements a reception unit that receives input from a user; and
an authentication control unit that, in response to receiving input of second identification information for an access point and the authentication code, transmits: the terminal registration request including the received authentication code, the certification information that is used in wireless communication with the access point, and the terminal identification information to the information processing device.

11. A non-transitory computer-readable medium including programmed instructions executed by a computer that causes the computer to:
switch between a registration mode in which execution of registration in management information to manage a terminal to be authenticated is enabled and a non-registration mode in which execution of the registration is disabled;
verify the authentication code in response to receiving: a terminal registration request including terminal identification information that identifies a terminal device, certification information expressing a public key or a certificate, and an authentication code that is determined in advance from the terminal device in the registration mode; and
in response to the authentication code being verified successfully, register the certification information and the terminal identification information included in the terminal registration request in association with each other in the management information.
